(19) United States
(12) Patent Application Publication
(10) Pub. No.: US 2008/0184258 A1
(43) Pub. Date: Jul. 31, 2008

(54) DATA PROCESSING SYSTEM

(76) Inventor: Keisuke Toyama, Yokohama (JP)

Correspondence Address: MILES & STOCKBRIDGE PC, 1751 PINNACLE DRIVE, SUITE 500, MCLEAN, VA, 22102-3833, US

(21) Appl. No.: 11/957,723

(22) Filed: Dec. 17, 2007

(30) Foreign Application Priority Data
Jan. 30, 2007 (JP) 2007-018701

(51) Int. Cl. G06F 9/50

(52) U.S. Cl. 718/106

(57) ABSTRACT

Multiple operating systems are operated on a multi-core system without applying any changes to the operating systems, and unauthorized function invocation and unauthorized data access among the operating systems are detected, thereby assuring high reliability. Access authorization is checked at two levels. At the upper level, a database managed by the multiple operating systems is provided. The database describes which procedure/function, task, or the like can be used to call a function. With reference to this information, it is determined whether invocation of the function has been authorized, by using an invocation authorization management program. At the lower level, access authorization for access to a memory eventually reached when the invocation processing is converted is checked by an access authorization management module using hardware.

### CLAIM OF PRIORITY

The present application claims priority from Japanese application JP 2007-018701 filed on Jan. 30, 2007, the content of which is hereby incorporated by reference into this application.

### FIELD OF THE INVENTION

The present invention relates to control of invocation authorization of data processing performed under the control of another operating system and to control of access authorization with respect to a shared hardware resource. Further, the present invention relates to a technique effective for improvement of reliability and security provided when an application program is executed in a data processing system using a microcomputer such as a multi-core processor in which multiple operating systems are operated on multiple central processing units, for example.

### BACKGROUND OF THE INVENTION

Recent years, integration in microprocessors has been advanced, and a multi-core processor having multiple individual central processing units (CPUs) has been developed as a multi-core system. In order to operate an application program on the multi-core processor having the multiple CPUs, it is necessary to have multiple operating systems (OSs), which are basic systems, and a method is required to exchange data between the OSs and to execute, in one of the OSs, a function belonging to another one of the OSs without paying attention to the existence of the multiple CPUs and OSs. To handle such cases, JP-A No. 2003-345614 proposes a technique in which an OS for a single processor and an existing application program are operated in a multiprocessor system and parallel processing performed by the multiprocessor system is realized for the application program. For example, a unit of process that can be handled in parallel in an application program executed in a first CPU is operated as a new unit of process in a second CPU.

In a multi-core processor in which a number of CPUs and other circuit modules are integrated on a single chip, complicated functions are associated with each other, and, therefore, reliability of the execution of an application needs to be assured. For example, when a memory space is partitioned into logical domains, invocation of data processing from an OS belonging to one of the domains needs to be partially restricted. However, if such restriction is fixed, flexibility which allows invocation of data processing over the domains, which have different OSs, is impaired. Therefore, it is necessary to achieve both the invocation of data processing over the domains, which have different OSs, and assured security for the execution of an application. Further, the inventors of the present invention have found out that, in order to improve the security, it is necessary not only to control the invocation of data processing belonging to a different OS from an application, but also to control access enable/disable with respect to a shared resource such as a memory, based on access authorization.

### SUMMARY OF THE INVENTION

An object of the present invention is to provide a data processing system which can realize, in a multi-CPU system in which multiple OSs each used for single CPU are operated, parallel data processing performed by one application program and improvement of security for invocation of a function over the multiple OSs.

Another object of the present invention is to provide a data processing system which can improve security for access to a shared resource in a multi-CPU system in which multiple OSs each used for single CPU are operated.

The above-mentioned and other objects and new characteristics of the present invention will be apparent from the description of the specification and the accompanying drawings.

An outline of a representative form of the present invention will be briefly described below.

In the present invention, a system configuration is divided into multiple layers and authorization is determined at two levels, an upper level and a lower level. At the upper level, a function invocation authorization management table managed by the multiple OSs is provided. The function invocation authorization management table describes for a functional feature which function, task, or the like can be used to call the functional feature. An invocation sequence changing means which handles function invocation from a certain OS to another OS determines whether the function invocation has been authorized by referring to invocation authorization information described in the function invocation authorization management table. Further, at the lower level, access authorization for access to a hardware resource such as a memory eventually reached when the invocation processing is converted is checked using hardware.

Effects of the representative form of the present invention will be briefly described below.

It is possible to realize, in a multi-CPU system in which multiple OSs each used for single CPUs are operated, parallel data processing performed by one application program and improvement of security for invocation of a function over the multiple OSs.

Further, it is possible to improve security for access to a shared resource in a multi-CPU system in which multiple OSs each used for single CPUs are operated.

### BRIEF DESCRIPTION OF THE DRAWINGS

FIG. 1 is a hardware block diagram of a data processing system according to the present invention;

FIG. 2 is a system configuration diagram showing the configuration of software and hardware in the data processing system shown in FIG. 1;

FIG. 3 is a hardware block diagram showing a concrete example of an access authorization management module;

FIG. 4 is a flowchart of a control operation sequence performed by the access authorization management module;

FIG. 5 is a flowchart of a control sequence of a utility program 110 executed in a higher-level privileged mode;

FIG. 6 shows a system configuration of the data processing system shown in FIG. 1, with domains taken into account in each of which one CPU performs data processing under the control of one OS; and

FIG. 7 is a flowchart of a task invocation processing procedure using an invocation authorization database (TCADB) and an invocation authorization management program (TCACNT).

### DETAILED DESCRIPTION OF THE PREFERRED EMBODIMENT

### 1. Representative Forms of Embodiment of the Invention

First, outlines of representative forms of embodiment of the present invention will be described. In the description of the representative forms of the embodiment, reference numerals in the drawings, which are referred in parentheses merely and partially indicate the concepts of the components to which they are given.

[1] A data processing system according to one representative form of the present invention includes: a memory area (100) used to store data and a program; multiple central processing units (101 to 103) for executing the program stored in the memory area; and an access authorization management module (140) for managing resource access authorization with respect to a hardware resource available for the multiple central processing units. When one central processing unit of the multiple central processing units performs data processing under the control of an operating system, the central processing unit controls invocation enable/disable of another data processing function performed under the control of another operating system, by referring to a function invocation authorization management table (151). This control performed based on the function invocation authorization assures security in an upper layer. The access authorization management module receives access authorization control information (250, 240) for the hardware resource, and controls access enable/disable with respect to the hardware resource corresponding to the access authorization control information, according to an entry that is included in an access authorization management table (261) and corresponds to the received access authorization control information. This control performed based on the access authorization assures security in a lower layer.

According to the above-mentioned data processing system, it is possible to restrict access to a hardware resource such as a memory based on access authorization used in the lower layer stronger than authorization used in the upper layer that is set by an OS, by using a function provided by hardware at the time of system design. At the time of application development, function invocation authorization used in the upper layer can be set flexibly by services or procedures/functions to be used by an application, without paying attention to the restriction provided at the time of system design. Significant access authorization which may have a large influence on a system behavior is checked by a lower-layer mechanism using hardware, so that high-level security is assured by eliminating an influence caused by unauthorized function invocation through an application program.

Accordingly, function invocation enable/disable can be desirably designed for each function in an application program at the time of software development. High-level security is assured by control of function invocation authorization and control of access authorization performed in domains as units in each of which one CPU performs data processing under the control of one OS. As a result, a high-reliable data processing system can be realized.

As one concrete form of the present invention, the memory area includes a shared area (100_3) accessible in a privileged mode in which the central processing unit executes the operating system, and the shared area stores the function invocation authorization management table. It is hard to falsify the function invocation authorization management table through an unauthorized application program.

As another concrete form of the present invention, the function invocation authorization management table contains a name of a procedure/function which identifies data processing, information on an operating system which has the procedure/function and controls execution of the procedure/function, and invocation authorization information on invocation authorization of an operating system other than the operating system which has the procedure/function, with respect to the procedure/function. Function invocation authorization can be managed with such a small amount of information.

As still another concrete form of the present invention, the access authorization management table is rewritable in a higher-level privileged mode which is superior to the privileged mode, in which the central processing unit executes the operating system. Even when the function invocation authorization management in the upper level is violated in an unauthorized manner, the access authorization management in the lower level can be prevented from being violated at the same time.

As still another concrete form of the present invention, the access authorization management table contains an address range and access authorization information with respect to the address range. The access authorization information contains information on the type of an operating system for which access is allowed and access type information indicating whether the allowed access is read or write. Access authorization can be managed with such a small amount of information.

[2] A data processing system according to another representative form of the present invention includes: a memory area used to store data and a program; and multiple central processing units for executing the program stored in the memory area. When an operating system (OS1) calls one procedure/function (F) executed under the control of another operating system (OS2), one central processing unit of the central processing units that operates under the control of the operating system refers to a first data section (the name of the procedure/function, and an OS which has the procedure/function) of a function invocation authorization management table (151) to find out an operating system on which the procedure/function is executed, and, when the procedure/function is executed under the control of the other operating system, determines whether to allow the operating system to call the procedure/function, by referring to a second data section (authorization) of the function invocation authorization management table.

With the above-mentioned configuration, it is possible to set function invocation authorization used in the upper layer, in a flexible manner by services or procedures/functions to be used by an application, and also to assure security by eliminating an influence caused by unauthorized function invocation through an application program.

As one concrete form of the present invention, an access authorization management module for managing resource access authorization with respect to a hardware resource available for the multiple central processing units is further provided. The access authorization management module receives access authorization control information for the hardware resource, and controls access enable/disable with respect to the hardware resource corresponding to the access authorization control information, according to an entry that is included in an access authorization management table and corresponds to the received access authorization control information.

With the above-mentioned configuration, it is possible to restrict access to a hardware resource such as a memory based on access authorization used in the lower layer stronger than authorization used in the upper layer that is set by an OS. Significant access authorization which may have a large influence on a system behavior is checked by a lower-layer mechanism in a hardware manner, so that high-level security can be assured by eliminating an influence caused by unauthorized function invocation through an application program.

[3] A data processor according to still another representative form of the present invention includes: multiple central processing units for executing a program; and an access authorization management module for managing resource access authorization with respect to a hardware resource available for the multiple central processing units, and is formed on a single chip. When an operating system calls one procedure/function and parameters of the procedure/function executed under the control of another operating system, one central processing unit of the central processing units that operates under the control of the operating system refers to a first data section of a function invocation authorization management table to find out an operating system on which the procedure/function and the parameters are executed, and, when the procedure/function and the parameters are executed under the control of the other operating system, determines whether to allow the operating system to call the procedure/function and its parameters, by referring to a second data section of the function invocation authorization management table.

### 2. First Embodiment

A first embodiment will be described in detail.

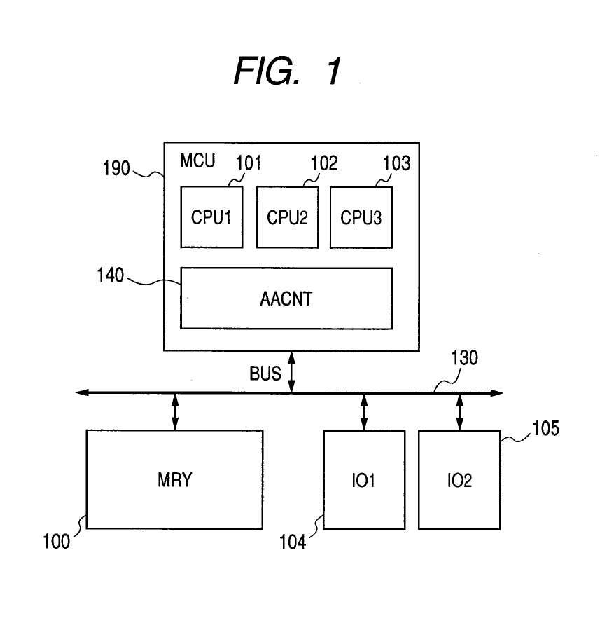

FIG. 1 is a hardware block diagram of a data processing system according to the present invention. The data processing system includes a data processor (MCU) 190, a memory (MRY) 100, and input/output circuits (IO1 and IO2) 104 and 105, all of which are typical components and connected in common to a transfer bus (BUS) 130. The data processor (MCU) 190 is configured as a multi-CPU (multi-core) processor having, for example, three central processing units (CPU1, CPU2, and CPU3) 101 to 103. Further, the data processor (MCU) 190 has an access authorization management module (AACNT) 140. The memory (MRY) 100 and the input/output circuits (IO1 and IO2) 104 and 105 are examples of hardware resources available for the central processing units (CPU1, CPU2, and CPU3) 101 to 103. The memory (MRY) 100 is used as an area that stores data and programs, such as operating systems and an application program executed by the central processing units (CPU1, CPU2, and CPU3) 101 to 103. The access authorization management module (AACNT) 140 is a circuit for managing resource access authorization with respect to hardware resources available for the central processing units (CPU1, CPU2, and CPU3) 101 to 103.

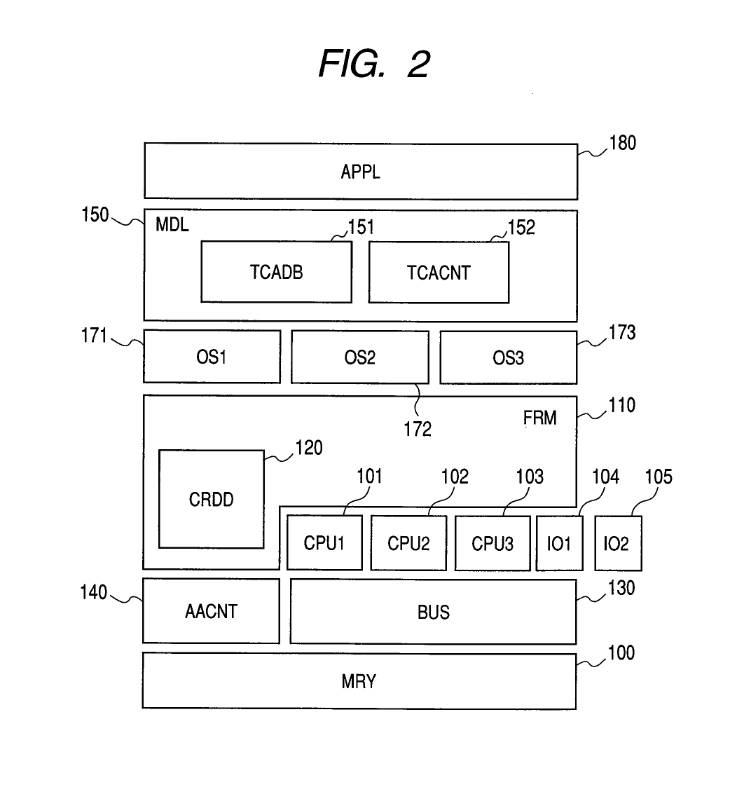

FIG. 2 shows the configuration of software and hardware in the data processing system shown in FIG. 1. On the central processing units (CPU1, CPU2, and CPU3) 101 to 103, operating systems (OS1, OS2, and OS3) 171 to 173 are operated, respectively. Under the control of the operating systems (OS1, OS2, and OS3) 171 to 173, a predetermined application program (APPL) 180 is operated. An upper-layer utility program (MDL) 150 which constructs middleware is provided between the operating systems (OS1, OS2, and OS3) 171 to 173 and the application program (APPL) 180. In FIG. 2, an invocation authorization database (TCADB) 151 and an invocation authorization management program (TCACNT) 152 are shown as the utility program (MDL) 150. The operating systems (OS1, OS2, and OS3) 171 to 173, the application program (APPL) 180, the invocation authorization database (TCADB) 151, and the invocation authorization management program (TCACNT) 152 are stored in the memory (MRY) 100, which is not particularly limited. The data processor (MCU) 190 has a lower-layer utility program (FRM) 110, and, in FIG. 2, a resource partitioning utility (CRDD) 120 is shown as the lower-layer utility program (FRM) 110. The utility program (FRM) 110 may be stored in the memory (MRY) 100 or stored in a special storage area configured by, for example, a ROM included in the data processor (MCU) 190.

Each of the operating systems (OS1, OS2, and OS3) 171 to 173 is used for a single CPU. The data processing system according to the present invention realizes a multi-CPU system in which the multiple operating systems (OS1, OS2, and OS3) 171 to 173 are operated. In the data processing system, when data processing is performed according to one application program, the central processing units (CPU1, CPU2, and CPU3) 101 to 103 use the invocation authorization database (TCADB) 151 and the invocation authorization management program (TCACNT) 152 to call a data processing function over the multiple operating systems (OS1, OS2, and OS3) 171 to 173 and to maintain security. In addition to the above security maintenance performed in the upper layer, security maintenance in the lower layer is performed by the access authorization management module (AACNT) 140 based on an access address and the like, when the central processing units (CPU1, CPU2, and CPU3) 101 to 103 access resources such as the memory (MRY) 100 under the control of the operating systems (OS1, OS2, and OS3) 171 to 173. Hereinafter, a detailed description will be given of a configuration for the security maintenance in the upper layer and the lower layer.

The invocation authorization management program (TCACNT) 152 refers to the invocation authorization database (TCADB) 151 to decide whether to allow data reference or function invocation such as invocation of an application or a utility on a certain operating system from an application of another operating system. The invocation authorization database (TCADB) 151 is only one invocation authorization database built in the memory (MRY) 100, for the entire data processing system.

The resource partitioning utility (CRDD) 120 adds a proper offset value to the value of a memory address to be referred by the application program (APPL) 180 and the operating systems (OS1, OS2, and OS3) 171 to 173, in cooperation with a hardware circuit such as an address computing unit, to allow an actual reference location on the memory (MRY) 100 to be physically shifted without being known by the application program (APPL) 180 and the operating systems (OS1, OS2, and OS3) 171 to 173. Therefore, even when the storage area of the memory (MRY) 100 is partitioned into areas for CPU1, CPU2, and the like, the application program (APPL) 180 and the operating systems (OS1, OS2, and OS3) 171 to 173 just need to manage an address space starting at address “0”. The central processing units (CPU1, CPU2, and CPU3) 101 to 103 access resources via the resource partitioning utility (CRDD) 120.

The access authorization management module (AACNT) 140 is a hardware circuit and checks a memory address output to the transfer bus (BUS) 130. A range of memory addresses and access authorization are specified in advance in the access authorization management module (AACNT) 140, so that it is possible to check whether a memory address accessed when the application program (APPL) 180 and the operating systems (OS1, OS2, and OS3) 171 to 173 are executed is permitted.

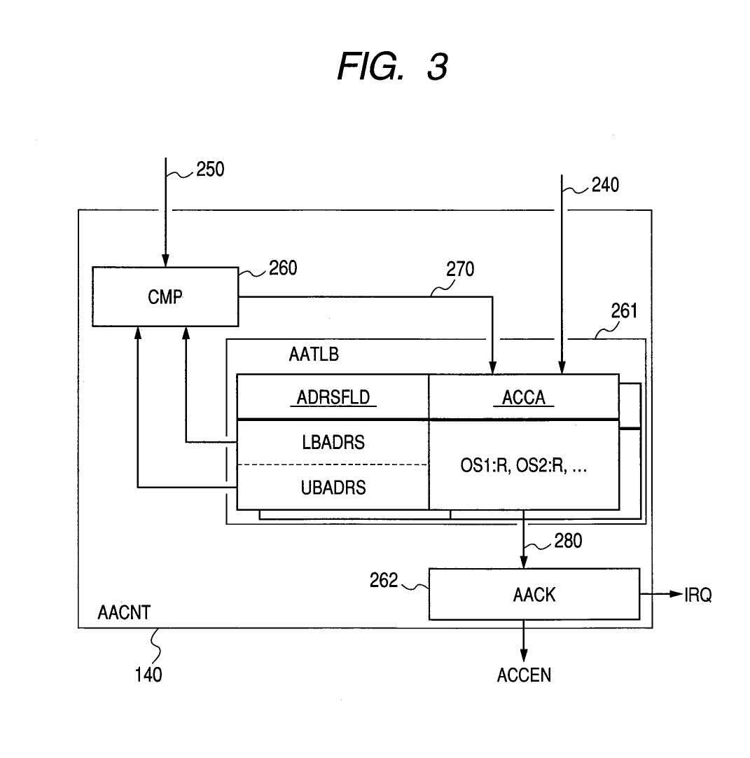

FIG. 3 shows a concrete example of the access authorization management module (AACNT) 140. The access authorization management module (AACNT) 140 includes a comparator (CMP) 260, an access authorization management table (AATLB) 261 in which access authorization is specified for each address range, and an access permission control circuit (AACK) 262. The access authorization management table (AATLB) 261 has multiple pieces of entry data specifying access authorization (ACCA) for each address range (ADRSFLD) defined by a lower limiting address (LBADRS) and an upper limiting address (UBADRS). The access authorization includes write enable, read enable, read and write enable, and access disable, for each operating system. For example, “OS1:R” indicates that read enable is specified for the operating system. The comparator (CMP) 260 determines the address range which includes the access address specified by an address signal 250 output from a CPU, and sends a selection signal 270 which selects entry data corresponding to the address range including the access address, to the access authorization management table (AATLB) 261. The access authorization management table (AATLB) 261 selects, from the entry data selected by the selection signal 270, access authorization of the OS specified by an OS specifying signal 240, and outputs it as an access authorization signal 280 to the access permission control circuit (AACK) 262. The access permission control circuit (AACK) 262 determines whether an access type requested by the access requester satisfies the access authorization indicated by the access authorization signal 280. When the access type satisfies the access authorization, an access enable signal ACCEN is output to the memory (MRY) 100 or the like. When the access type does not satisfy the access authorization, an interruption signal IRQ is sent to the CPU to request an interruption. The OS specifying signal 240 is output by the CPU together with the access address when the CPU accesses the resource.

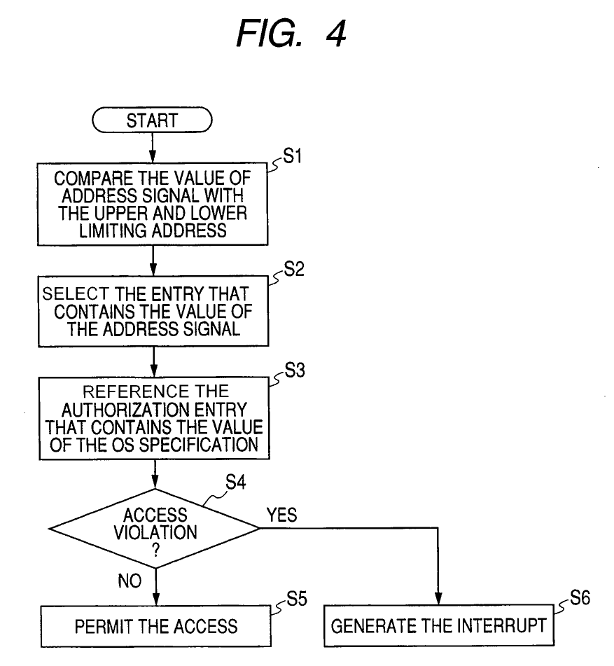

FIG. 4 shows a control operation sequence performed by the access authorization management module (AACNT) 140. The address range is determined which includes the access address specified by the address signal 250 (SI). The entry data corresponding to the address range including the access address is selected by the selection signal 270 (S2). From an access authorization (ACCA) field of the selected entry data, access authorization of the OS specified by the OS specifying signal 240 is referenced (S3). It is determined whether the access type requested by the access requester violates the referenced access authorization, which is specified by the access authorization signal 280 (S4). When the access type does not violate the access authorization, the access is permitted (S5). When the access type violates the access authorization, an interruption request is issued (S6). The OS on which the program that has caused this interruption event is operating performs error processing according to an interrupt processing program.

The entry data included in the access authorization management table (AATLB) 261 is used to check a violation of access authorization, and cannot be written by the operating systems (OS1, OS2, and OS3) 171 to 173 or the application program (APPL) 180, serving as a user program. In general, a CPU is operated in one of multiple operation modes classified into a user mode and a privileged mode. When the CPU is operated in the user mode, there are CPU resources that are not accessible and instructions that cannot be executed. The central processing units (CPU1, CPU2, and CPU3) 101 to 103 are provided with a higher-level privileged mode which is superior to the privileged mode. The entry data of the address range (ADRSFLD) and the access authorization (ACCA), included in the access authorization management table (AATLB) 261, is a resource that cannot be written in the privileged mode but can be rewritten only in the higher-level privileged mode. The utility program (FRM) 110 such as the resource partitioning utility (CRDD) 120 is software to be executed in the higher-level privileged mode. The utility program (FRM) 110 is executed when operation processing in the higher-level privileged mode is requested.

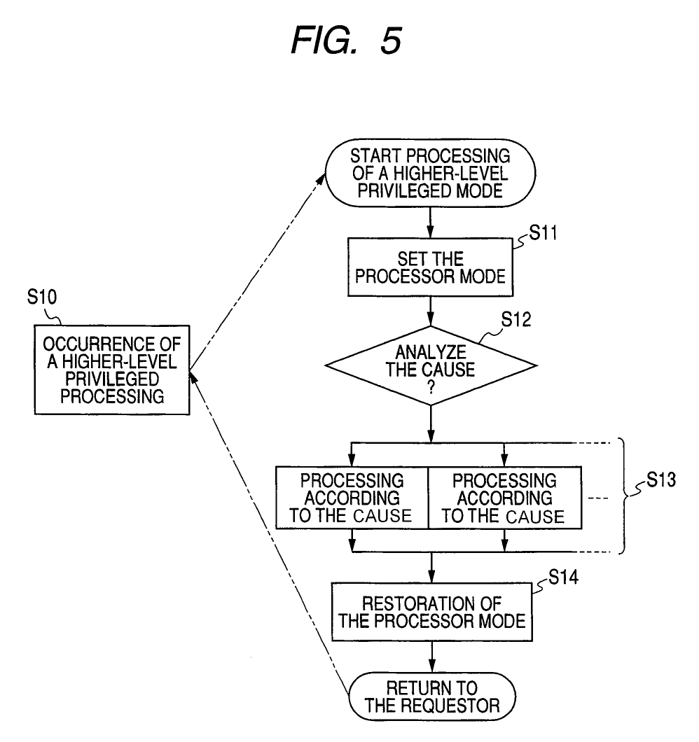

FIG. 5 shows a processing flow of the utility program (FRM) 110 executed in the higher-level privileged mode. When a processing request in the higher-level privileged mode is made by one of the application program (APPL) 180 and the operating systems (OS1, OS2, and OS3) 171 to 173 (S10), processing is started in the higher-level privileged mode. First, the operation mode of the data processor (MCU) 190 is set to the higher-level privileged mode (S11). Next, cause analysis is performed to find out a requested process (S12). The cause analysis is performed by referring to an instruction that has caused the processing in the higher-level privileged mode, the number corresponding to a service, the type of a requested service, or the like. Each required process is performed based on the result of the cause analysis (S13). When the required process is ended, the data processor (MCU) 190 is set back to the operation mode in which the data processor (MCU) 190 had been operated before the processing was started in the higher-level privileged mode (S14), and the flow returns to the request source.

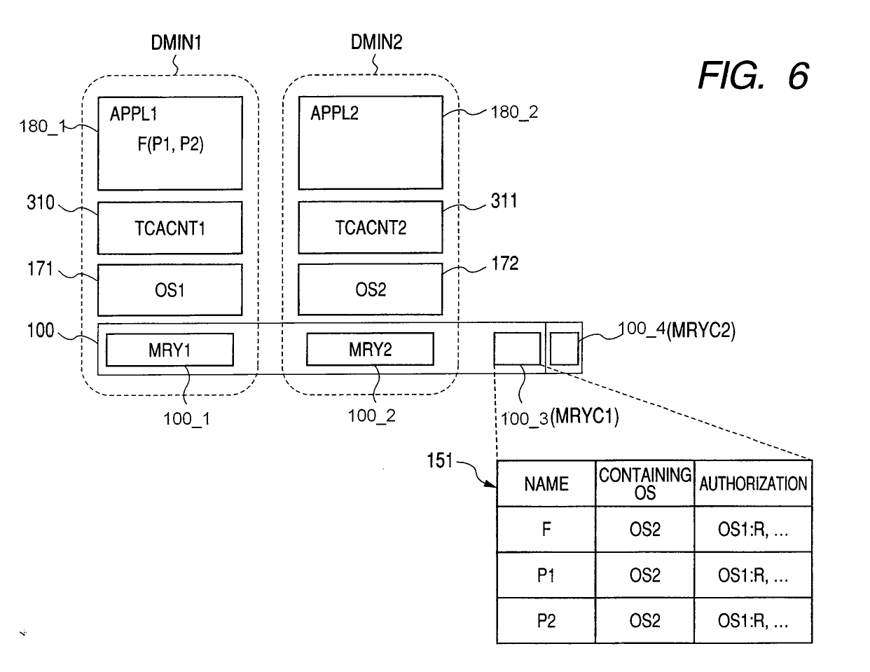

FIG. 6 shows a system configuration of the data processing system shown in FIG. 1, with domains taken into account in each of which one CPU performs data processing under the control of one OS. In FIG. 6, it is assumed that the invocation authorization management program (TCACNT) 152 is operated, on the OSs, as tasks, i.e., invocation authorization management tasks (TCACNT1 and TCACNT2) 310 and 311, in the respective domains. The invocation authorization database (TCADB) 151 is stored in a shared area (MRYC1) 100_3 on the memory (MRY) 100, which can be referenced by the invocation authorization management tasks (TCACNT1 and TCACNT2) 310 and 311. The shared area (MRYC1) 100_3 is writable in the privileged mode. A memory area (MRY1) 100_1 is allocated for a domain DMIN1, a memory area (MRY2) 100_2 is allocated for a domain DMIN2, and a shared area (MRYC2) 100_4 is readable and writable in any operation mode.

In the invocation authorization database (TCADB) 151, the name of a procedure/function, parameters, an OS that contains the procedure/function and the parameters, and authorization are registered, which is not particularly limited. In the authorization, for example, “OS1:R” indicates that invocation is allowed for the operating system (OS1) 171, that is, execution of a procedure/function F is allowed for the operating system (OS1) 171. The same applies to parameters “P1” and “P2”.

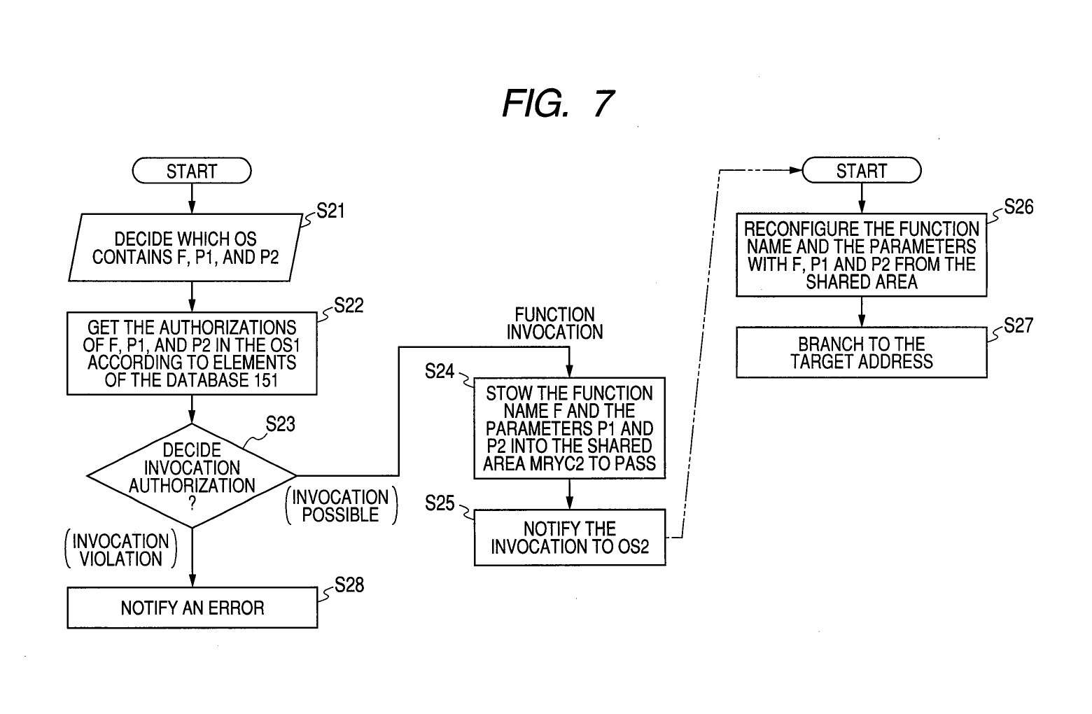

In FIG. 6, it is assumed that an application program (APPL1) 180_1 of the operating system (OS1) 171 on the central processing unit (CPU1) 101 is set to F(P1, P2) and a procedure/function F of an application program (APPL2) 180_2 of the operating system (OS2) 172 on the central processing unit (CPU2) 102 is called by using the parameters P1 and P2. FIG. 7 shows a flowchart of a function invocation processing procedure. In this embodiment, it is assumed that the value of the parameter P2 is just passed to the procedure/function F but the parameter P1 is used to change the value in the memory, in the procedure/function F of the application program (APPL2) 180_2.

The task invocation processing procedure will be described based on FIG. 7. When execution of the application program (APPL1) 180_1 advances and invocation is made using F(P1,P2), conversion processing is performed in the invocation authorization management task (TCACNT1) 310 on the operating system (OS1) 171. This processing procedure is shown in FIG. 7.

Referring to FIG. 7, an operating system that contains the procedure/function F is determined (S21), and the target operating system (in this case, OS2) is obtained. In Step S22, authorization of the operating system (OS1) 171 with respect to the procedure/function F is obtained from entry data in the invocation authorization database (TCADB) 151. It is determined whether the referenced authorization indicates “R” (invocation enable=executable) (S23). When the referenced authorization indicates “R”, invocation of the procedure/function F is passed to the operating system (OS2) 172. Authorization with respect to each of the parameters P1 and P2 is similarly referenced and it is determined whether the authorization indicates “R” (S21 to S23). In the example of FIG. 6, it is determined that the authorization with respect to all of the procedure/function F and the parameters P1 and P2 indicates that invocation is enabled in the operating system (OS1) 171. Accordingly, the name of the procedure/function F and the parameters P1 and P2 are stored in the shared area (MRYC2) 100_4 (S24). The operating system (OS2) 172 is notified of the invocation (S25). The operating system (OS2) 172, which has been notified of the invocation, uses the invocation authorization management task (TCACNT2) 311 to obtain the name of the procedure/function F and the parameters P1 and P2 from the shared area (MRYC2) 100_4, and reconfigures the procedure/function name and the parameters into such a format that a program on the operating system (OS2) 172 can process them (S26). The execution branches to the start address of the target procedure/function identified by the reconfigured procedure/function name (S27). The target procedure/function is executed by using the parameters P1 and P2 passed in the same way. In a case where a resource such as the memory (MRY) 100 needs to be accessed during execution of the procedure/function, memory access or the like is allowed within the range of access authorization permitted by the access authorization management module (AACNT) 140, which has been described with reference to FIG. 3.

In Step S23, when it is determined that the authorization of the operating system (OS1) 171 with respect to the procedure/function F does not indicate “R”, invocation of the procedure/function F is not allowed for the operating system (OS1) 171 and error processing is performed in the operating system (OS1) 171 (S28).

In addition to the control of enable/disable of task invocation, performed by the invocation authorization management program (TCACNT) 152, which has been described based on FIGS. 6 and 7, enable/disable of access which is performed based on data passed by a parameter and which is hard to check or takes time with that task invocation control is also easily checked through the access authorization management module (AACNT) 140. For example, it is assumed that, in processing of the procedure/function F, data passed by the parameter P1 indicates the address of a certain memory area and the value in the memory area is changed in the procedure/function F. At this time, since invocation of the procedure/function F itself is allowed according to authorization check performed by the invocation authorization management program (TCACNT) 152, it cannot be determined, by only the invocation authorization management program (TCACNT) 152 and the operating system (OS2) 172, whether to allow memory access using the parameter P1. To deal with this, an access authorization check mechanism for the lower level, which has been described with reference to FIG. 3, is used. For an address of memory accessed using the parameter P1, the address range from the lower limiting address (LBADRS) to the upper limiting address (UBADRS) and access authorization (ACCA) corresponding to the address range are specified in advance in the access authorization management table (AATLB) 261. When the memory area is accessed using the parameter P1 while the procedure/function F is being executed, whether the access is allowed is determined according to the sequence described with reference to FIG. 4. Specifically, with respect to the access to the memory area, first, the comparator (CMP) 260 compares the access address specified by the address signal 250 sent from the central processing unit (CPU2) 102 to the transfer bus (BUS) 130 with each of the address ranges (from LBADRS to UBADRS) of all pieces of entry data (S1). The entry data corresponding to the address range including the access address is selected (S2), and access authorization (ACCA) for the address range of this entry data is obtained (S3). For example, the access authorization of the operating system (OS2) 172 with respect to the address passed by the parameter P1 indicates “R” and write disable. At this point, “access violation” is issued as an access authorization signal 280 from the access authorization check mechanism. An interruption signal IRQ is issued based on the access authorization signal 280, indicating the “violation”, and the central processing unit (CPU2) 102 under the control of the operating system (OS2) 172 recognizes that an access error occurs. This access authorization management for the lower level is realized by a hardware circuit and access authorization control is performed at a high speed.

In the above-described data processing system, it is possible to flexibly control access authorization for invocation for each procedure/function as a unit, depending on the configuration of an application. Further, for each procedure/function, higher-level check of access authorization based on hardware can be realized without overhead. The former access authorization control is realized by the invocation authorization database (TCADB) 151 and the invocation authorization management program (TCACNT) 152, and the latter access authorization control is realized by the access authorization management module (AACNT) 140.

The present invention has been specifically described based on the embodiment. The present invention is not limited to the embodiment. It is needless to say that various changes may be made without departing from the scope of the invention.

For example, the data processor (MCU) 190 is not limited to a single chip but may have a multi-chip configuration. Further, the number of CPUs used for the data processor (MCU) 190 is not limited to three. A target to be managed based on access authorization by the access authorization management module (AACNT) 140 is not limited to a memory. An accessible resource from CPU, i/o circuit for example, may be such a target. The structure of the access authorization management table (AATLB) 261 is not limited to that shown in FIG. 3. The access authorization management table (AATLB) 261 may have a data structure in which an address range is specified by higher-order bits of an address signal, for example.

What is claimed is:

1. A data processing system comprising:
a memory area used to store data and a program;
a plurality of central processing units executing the program stored in the memory area; and
an access authorization management module managing resource access authorization with respect to a hardware resource available for the plurality of central processing units, wherein:
central processing units that perform data processing under the control of an operating system control invocation enable/disable of another data processing function performed under the control of another operating system, by referring to a function invocation authorization management table; and
the access authorization management module receives access authorization control information for the hardware resource, and controls access enable/disable with respect to the hardware resource corresponding to the access authorization control information, according to an entry that is included in an access authorization management table and corresponds to the received access authorization control information.

2. A data processing system according to claim 1, wherein:
the memory area comprises a shared area accessible in a privileged mode in which the central processing unit executes the operating system; and
the shared area stores the function invocation authorization management table.

3. A data processing system according to claim 1, wherein the function invocation authorization management table contains a name of a procedure/function which identifies data processing, information on an operating system which has the procedure/function and controls execution of the procedure/function, and invocation authorization information on invocation of an operating system other than the operating system which has the procedure/function, with respect to the procedure/function.

4. A data processing system according to claim 1, wherein the access authorization management table is only rewritable in a higher-level privileged mode which is superior to a privileged mode in which the central processing unit executes the operating system.

5. A data processing system according to claim 1, wherein:
the access authorization management table contains an address range and access authorization information with respect to the address range; and
the access authorization information contains information on the type of an operating system for which access is allowed and access type information indicating whether the allowed access is read or write.

6. A data processing system comprising:
a memory area used to store data and a program; and
a plurality of central processing units executing the program stored in the memory area,
wherein, when an operating system calls one procedure/function executed under the control of another operating system, one of the plurality of central processing units that operates under the control of the operating system refers to a first data section of a function invocation authorization management table to find out an operating system on which the procedure/function is executed, and, when the procedure/function is executed under the control of another operating system, determines whether to allow the operating system to call the procedure/function, by referring to a second data section of the function invocation authorization management table.

7. A data processing system according to claim 6, further comprising an access authorization management module for managing resource access authorization with respect to a hardware resource available for the plurality of central processing units,
wherein the access authorization management module receives access authorization control information for the hardware resource, and controls access enable/disable with respect to the hardware resource corresponding to the access authorization control information, according to an entry that is included in an access authorization management table and corresponds to the received access authorization control information.

8. A data processing system according to claim 6, wherein:
the memory area comprises a shared area accessible in a privileged mode in which the central processing unit executes the operating system; and
the shared area stores the function invocation authorization management table.

9. A data processing system according to claim 6, wherein:
the function invocation authorization management table contains a name of a procedure/function which identifies data processing, information on an operating system which has the procedure/function and controls execution of the procedure/function, and invocation authorization information on invocation authorization of an operating system other than the operating system which has the procedure/function, with respect to the procedure/function;
the first data section is an area that stores information on the operating system which has the procedure/function, paired with the name of the procedure/function; and
the second data section is an area that stores invocation authorization information paired with the name of the procedure/function.

10. A data processing system according to claim 7, wherein the access authorization management table is only rewritable in a higher-level privileged mode which is superior to a privileged mode in which the central processing unit executes the operating system.

11. A data processing system according to claim 7, wherein:
the access authorization management table contains an address range and access authorization information with respect to the address range; and
the access authorization information includes information on the type of an operating system for which access is allowed and access type information indicating whether the allowed access is read or write.

12. A data processor configured on a chip, comprising:
the plurality of central processing units executing a program; and
an access authorization management module managing resource access authorization with respect to a hardware resource available for the plurality of central processing units,
wherein, when an operating system calls one procedure/function and parameters of the procedure/function executed under the control of another operating system, one of the plurality of central processing units that operates under the control of the one operating system refers to a first data section of a function invocation authorization management table to find out an operating system on which the procedure/function and the parameters are executed, and, when the procedure/function and the parameters are executed under the control of the other operating system, determines whether to allow the operating system to call the procedure/function and the parameters, by referring to a second data section of the function invocation authorization management table.
